(19) United States
(12) Patent Application Publication
(10) Pub. No.: US 2004/0216696 A1
(43) Pub. Date: Nov. 4, 2004

(54) Guiding installation for horses

(76) Inventor: Theo Haring, Dettighofen (DE)

Correspondence Address: SPECKMAN LAW GROUP PLLC, 1501 WESTERN AVE, SEATTLE, WA, 98101, US

(21) Appl. No.: 10/782,509

(22) Filed: Feb. 18, 2004

(30) Foreign Application Priority Data
Feb. 18, 2003 (DE) 103 06 667.5
Jul. 2, 2003 (DE) 103 29 891.6

(51) Int. Cl. B61B 9/00

(52) U.S. Cl. 119/784

(57) ABSTRACT

The present invention relates to a guiding installation for training horses, camels, and other animals without a person guiding the animals. The guiding installation is provided with a travel rail positioned at a distance over a training circuit of the guiding installation and a guide grating traction suspended from the travel rail. The guide grating traction may be provided with at least one drive carriage and a plurality of runner carriages or a plurality of drive carriages. The guiding installation is additionally provided with a plurality of guide gratings which are suspended from the runner carriages and/or drive carriages.

### CLAIM FOR FOREIGN PRIORITY UNDER 37 U.S.C. § 119

This application claims foreign priority to German Patent Application Nos. 103'06'667.5, filed Feb. 18, 2003, and 103'29'891.6, filed Jul. 2, 2003.

### FIELD OF INVENTION

The invention relates to a guiding installation for training horses, camels, and other animals without a person guiding the animals.

### BACKGROUND OF THE INVENTION

Free movement guiding installations for training horses which can be assembled on an open field or in an arena are known in the art. Such installations include a circular longeing path which is also called a hoof pad. Instead of being guided by a person, the horses are guided by a device on this longeing path. This device, similar to a carrousel, consists of a hub-spoke construction comprising support arms projecting radially outwards from a rotational center. A guide grating hangs downwards on each support arm at its radial outer region. Each guide grating is provided with a frame which is covered by a metal grating. The horses must run around in a horse guiding region between, in each case, two neighbouring guide gratings on the longeing path according to a predetermined speed. The longeing path is sufficiently wide that the horses may turn around if the rotational direction of the device is changed. The guide gratings may be electrically charged so that the horses do not attempt to reduce the speed of the whole installation by utilizing their bodies to brake. These installations have a great weight so that the hub-spoke design is sufficiently stable. Since these guide gratings hang from the support arms of the hub-spoke support design, they tend to swing and add great load on the support design by the large lever arms, resulting in repeated alternating stress breakage in the support design. Horses, during training, may strike and damage the gratings with their hooves. Such a free movement guiding installation is taught in German patent DE 28 52 777 A1.

German patent DE 19746562 shows another design of a free movement guiding installation for training horses with a circular longeing path. This design is limited on the inside and outside with, in each case, a fence or a wall, and is provided with supports for supporting a roof. In the region of the longeing path, a support design is arranged hanging down from a support. At the lower end of the support design, one support wheel is attached on both sides. The support wheels are arranged at an angle to one another and engage obliquely downwards onto a revolving profile ring. The support wheels guide and carry the revolving profile ring. A drive motor acts on and drives the profile ring via a drive wheel. Guide gratings are suspendingly attached at equal distances to one another on the profile ring. Each guide grating is provided with a frame which is covered with a metal grating. This system has severe dynamic problems due to the size and mass of the guide gratings. These problems lead to the production of noise, shaking, and irregular running of the free movement guiding installation.

The disadvantage of these installations is that they may only be utilized with circular training paths. The diameter of a circular training path is limited since the design of these installations is bulky and very heavy. Also, the danger of stress breakages in the components becomes significant in a large installation since the unavoidable vibrations add increased load to the material.

### SUMMARY OF THE INVENTION

It is the object of the present invention to provide a horse guiding installation having a small mass in relation to the size of the installation. It is another object of the present invention to provide an installation that may be operated on, in addition to a circular training path, an oval-shaped training path, thus rendering a significantly longer training circuit. An additional advantage of the present invention is that the installation may be operated on very long training circuits in almost any shape. Furthermore, the guiding installation of the present invention may also be provided with crossings and junctions.

The guiding installation of the present invention is provided with a travel rail positioned at a distance over a training circuit of the guiding installation. The travel rail is provided with a carrier surface and a support surface. A guide grating traction is suspended from, and travels along, the travel rail. The guide grating traction is provided with either: (a) a plurality of drive carriages coupled to one another; or (b) a drive carriage and a plurality of runner carriages coupled thereto. A plurality of guide gratings may be suspended from the runner carriages or the drive carriages. The guide gratings are arranged around the training circuit at a distance to one another, suspended on either the runner carriages or the drive carriage.

The drive carriage may be provided with a motor that drives at least one drive wheel. The drive wheel bears on the travel rail and rolls on the carrier surface of the travel rail. The drive carriage may also be provided with a counter thrust wheel that secures the drive wheel to the drive carriage via counter thrust. The travel rail may be additionally provided with at least two round profiles distanced to one another. At least one of the two round profiles may be a carrier profile on which the carrier wheels run.

The runner carriage may comprise at least one carrier wheel which supports the weight of the runner carriage and the guide gratings. The runner carriage may further comprise at least two support wheels which bear on the travel rail so that movement of the runner carriage transverse to the travel rail is prevented.

The guiding installation may further be provided with a current rail in the region of the travel rail and the drive carriage may be provided with a current collector.

### BRIEF DESCRIPTION OF THE DRAWINGS

The free movement guiding installation according to the present invention is hereinafter described in combination with the drawings, wherein:

FIG. 1 shows a top view of an embodiment of a horse guiding installation of the present invention with an approximately oval-shaped training circuit;

FIG. 2 shows a cross sectional view of the guiding installation of FIG. 1, illustrating the guide grating traction;

FIG. 3 shows a cross sectional view of the guiding installation of FIG. 1, illustrating a support frame installed with the travel rail;

FIG. 4 shows a frontal cross sectional view of an embodiment of the runner carriage of the guiding installation, positioned transverse to the travel rail;

FIG. 4A shows a side cross sectional view of another embodiment of the runner carriage of the guiding installation;

FIG. 4B shows a side cross sectional view of a further embodiment of the runner carriage of the guiding installation;

FIG. 5 shows a cross sectional view of an embodiment of the drive carriage of the guiding installation, positioned transverse to the travel rail;

FIG. 6A shows a cross sectional view of an embodiment of the travel rail of the guiding installation, illustrating a straight travel rail;

FIG. 6B shows a cross sectional view of another embodiment of the travel rail of the guiding installation, illustrating a randomly shaped travel rail;

FIG. 6C shows a cross sectional view of a further embodiment of the travel rail of the guiding installation, illustrating a double angle shaped travel rail;

FIG. 6D shows a cross sectional view of yet another embodiment of the travel rail of the guiding installation, illustrating a double T-shaped travel rail; and

FIG. 6E shows a cross sectional view of still another embodiment of the travel rail of the guiding installation, illustrating a T-shaped travel rail.

### DETAILED DESCRIPTION OF THE INVENTION

All horse guiding installations wherein the horse is not led by a person are based on the principle of a carousel. The guide gratings of such installations are suspended on a circular and rotatable design.

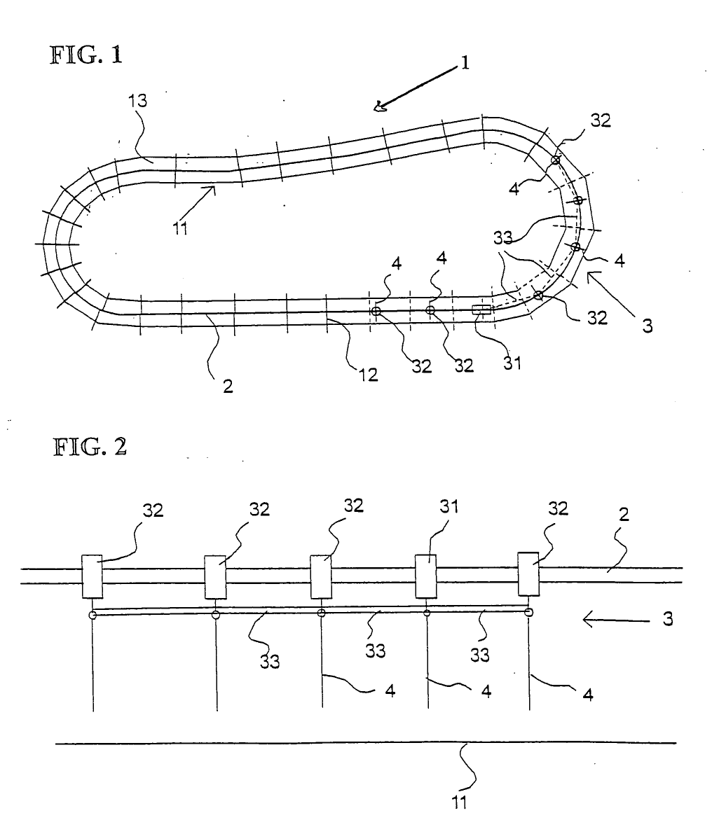

FIG. 1 shows the guiding installation 1 of the present invention. The guiding installation 1 comprises a travel rail 2 which is suspended above a training circuit 11. A guide grating traction 3 travels similar to a cable car from, on, or below the travel rail 2.

A plurality of support frames 12 are arranged along the training circuit 11 at approximately equal distances to each other. The travel rail 2 is fastened to and hangs from the support frames 12. The travel rail 2 is positioned approximately over the middle of the training circuit 11. The support frames 12 may carry an arcade roof 13 so that the entire training circuit 11 may be operated in a covered manner. The support frames 12 hold the travel rail 2 at a distance about 3 meters (m) or higher above the training circuit 11.

The guide grating traction 3 travels around the training circuit 11 on the travel rail 2. The guide grating traction 3 is provided with a drive carriage 31 and a runner carriage 32. Guide gratings known in the art are fastened to and suspended from the drive carriage 31 and the runner carriage 32. The guide grating traction 3 shown in FIG. 2 comprises a drive carriage 31 and a plurality of runner carriages 32. In one embodiment, every second runner carriage 32 is provided with a guide grating 4. The runner carriage 32 and the drive carriage 31 in each case are connected by a coupling rod or a pull cable 33 and are held at a constant distance to one another. The distance between the two runner carriages 32 provided with guide gratings 4 may be, for example, approximately 8 m and the distance between the runner carriage 32 and the drive carriage 31 may be approximately 4 m. This design ensures the stability of the guide grating tractions 3, even at relatively tight angled curves. In another embodiment not shown in the figures, the guide grating traction 3 comprises a plurality drive carriages 31 and each drive carriage 31 is provided with a guide grating 4.

A basic type of electrical current conducting rail may be arranged in the region of the travel rail 2. With this design, the drive carriage 31 is provided with current collectors 5. The travel direction and the speed may be controlled in a manner known in the art. The control may be positioned either centrally at the current supply to the current conducting rails or inside the drive carriage 31.

In addition to being oval-shaped, the training circuit 11 of the guiding installation 1 of the present invention may have various different shapes. For example, the training circuit 11 may be constructed with various different curves where a different radius is measured at each curve from the center of the training circuit 11. In another embodiment not shown in the figures, the guiding installation 1 is provided with an open training path with two end stations, wherein the guide grating traction reverses the travel direction when it reaches one end station. In a further embodiment, junctions with points may be provided on the travel rail. This embodiment provides a completely new training variation for horses, camels and other animals.

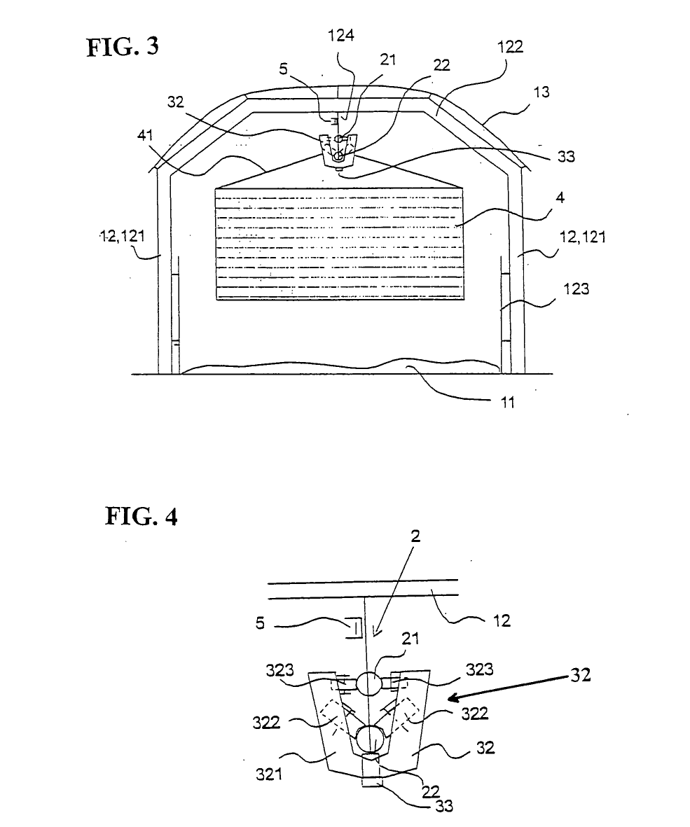

An elevated support frame 12 is shown in FIG. 3. The support frame 12 comprises two parallel supports 121 which are connected at the top via bows 122. The parallel supports 121 are fastened on the ground adjacent to the actual training circuit 11. A fence or a hoof strike protection 123 may be attached to the parallel supports 121. A suspension 124 for the travel rail 2 is held by the bow 122. The position of the guide grating 4 is evident during the passage of the guide grating traction 3 (not shown in FIG. 3). Various types of guide gratings 4 known in the art may be used. The guide gratings 4 may also be electrically charged during operation of the guiding installation 1. In a different embodiment not shown in the figures, the support frame 12 may be asymmetric, comprising a lateral support 121 and a projecting bow 22 one side.

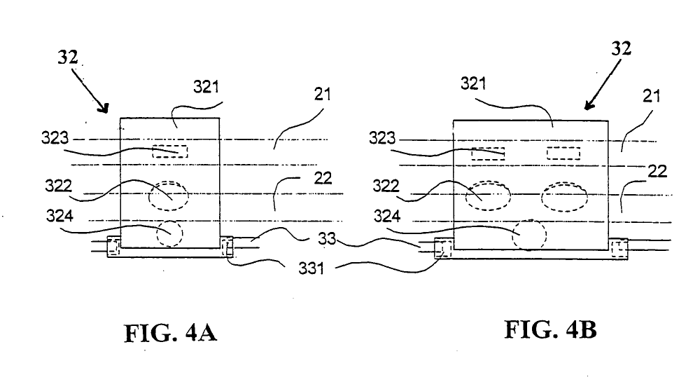

FIG. 4 shows an embodiment of the runner carriage 32 of the guiding installation 1, positioned transverse to the travel rail 2. The runner carriage 32 is provided with a guide profile 21 at the top and a support profile 22 at a distance below the guide profile 21. In FIG. 4, both the guide profile 21 and the support profile 22 are shown as profile rods with a round cross section. The runner carriage 32 comprises a chassis 321 which partly encompasses both profiles 21, 22. The chassis 321, which is approximately U-shaped, is closed below the support profile 22. The runner carriage 32 is additionally provided with two carrier wheels 322 which are arranged at an angle between approximately 60° and 90° to one another. The two carrier wheels 322 roll at a corresponding angle on the surface of the support profile 22. One support wheel 323, acting as a stabilizer, is located on each side in the free limb region of the U-shaped chassis 321. The support wheels 323 roll opposite one another laterally on the guide profile 21 of the travel rail 2. This design prevents the runner carriage 32 from swinging transversely to the travel rail 2. Lateral swinging of the guide gratings 4 is also indirectly prevented via the suspension on the runner carriage 32. A current collector 5 may be provided on the drive carriage 31.

As shown in FIG. 4A, a safety roller 324 may be provided in the chassis 321 so that it runs below the support rail 22. The safety roller 324 prevents the runner carriage 32 from lifting away from the travel rail 2.

In the embodiment shown in FIG. 4A, the runner carriage 32 is provided with a carrier wheel 322 and a support wheel 323 on each side of the chassis 321. In another embodiment of the runner carriage 32, shown in FIG. 4B, two carrier wheels 322 and two support wheels 323 are arranged behind one another on each side of the chassis 321. This design ensures a smoother running of the guide installation. The coupling rod or pull cable 33 is fastened to the runner carriage 32 and the drive carriage 31 via a laterally pivotable coupling 331. Coupling 331 may be a coupling pin. A cardanic coupling or a rubber element may also be used.

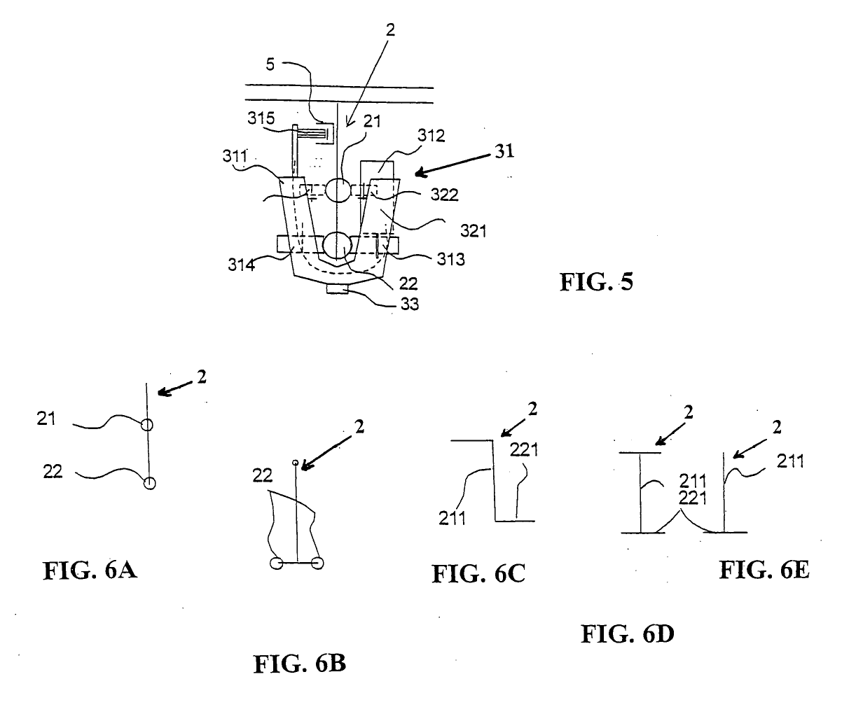

FIG. 5 shows a drive carriage 31 of the guiding installation. The chassis 311 of the drive carriage 31 is constructed similarly to the chassis 321 of the runner carriage 32 shown in FIG. 4. A motor 312 is laterally arranged on the chassis 311. The motor 312 drives a drive wheel 313 which runs approximately horizontally on and adjacent to the support profile 22 of the travel rail 2. A counter thrust wheel 314 is provided on the other limb of the chassis 311, positioned opposite to the drive wheel 313. The counter thrust wheel 314 presses against the support profile 22 under spring bias, ensuring the required adhesion for the drive wheel 313. Alternatively, two drive wheels 313 with two motors may be arranged lying opposite one another. In yet another embodiment, support wheels 322 and a safety wheel 324 may be provided similar to those of the runner carriage 32. The support wheels 322 are not needed as long as no guide grating 4 is arranged below the drive carriage 31. A current collector 5 with sliding contacts 315 may be provided on the drive carriage 31. The sliding contacts 315 traverse along the current rails, which are arranged laterally next to the travel rail 2 or above on the suspension of the travel rail 2 along the complete circuit 11. Current rails and sliding contacts known in the art such as those used in crane trolleys and crane ways may be used.

The guide grating traction 3 comprises at least one drive carriage 31. The number of drive carriages 31 may be varied. As shown in FIG. 2, the drive carriages 31 and the runner carriages 32 are connected to one another by coupling rods or pull cables 33. The pull cables 33 maintain the carriages at fixed distances to one another and transmit all tensile forces and braking forces from carriage to carriage. Thus adjacent guide gratings 4 are always located at a predetermined distance to one another. Additional runner carriages 32 or drive carriages 31 may be suspended from the travel rail 2.

Various embodiments of travel rails 2 are shown in FIGS. 6A-E. FIG. 6A shows a straight travel rail 2; FIG. 6B shows a randomly shaped travel rail 2; FIG. 6C shows a double angle shaped travel rail 2; FIG. 6D shows a double T-shaped travel rail 2; and FIG. 6E shows a T-shaped travel rail 2. Each embodiment of the travel rail 2 comprises a carrier surface 221 and a support surface 211. The support wheels 322 of the runner carriage 32 and/or the drive wheels 313 and the counter thrust wheels 314 of the drive carriage 31 roll on the support surface 211.

Embodiments of the runner carriage 32 and the drive carriage 31 wherein the guide profile 21 and support profile 22 are circular in cross-section are particularly suitable for smooth running of the guide grating traction 3. As shown in FIG. 3, the round profiles 21, 22 are fastened to the suspension 124 on the support frame 12. The arrangement of the two round profiles 21, 22 next to one another is mutually fastened with regular transverse supports. In this embodiment, the carrier rail is suspended from a carrier cable at regular distances, similar to a railway overhead cable. The drive carriage 31 and the runner carriage 32 roll on this carrier rail like a cable car or a self-driven gondola. In this embodiment, the counter thrust wheels 314 are not required since the adhesion for the drive wheels 313 is provided by the intrinsic weight of the drive carriages 31.

The guide grating traction 3 of the present invention may be provided with as many runner carriages 32 and drive carriages 31 as required. The present invention permits approximately any shape of training circuit 11. The training circuit 11 does not have to be a closed circuit because the travel direction may be reversed. Thus a training circuit 11 may be designed with curves and straight stretches, and with or without gradients. The training circuit may also be several kilometers in length.

I claim:

1. A guiding installation for training an animal, comprising:
(a) a travel rail positioned at a distance above a training path along which the animal travels;
(b) a guide grating traction which is suspended from and travels along the travel rail, the guide grating traction comprising a plurality of drive carriages; and
(c) a plurality of guide gratings which travel around the training path, each of the guide gratings being suspended on one of the plurality of drive carriages.

2. The guiding installation according to claim 1, wherein each of the plurality of drive carriages comprises a motor which drives a drive wheel, and wherein the drive wheel bears upon the travel rail.

3. The guiding installation according to claim 2, wherein the travel rail is a profile rod and comprises a carrier surface on which the drive wheel of the drive carriage rolls.

4. The guiding installation according to claim 2, wherein each of the plurality of drive carriages further comprises a counter thrust wheel which secures the drive wheel to the drive carriage via counter thrust.

5. The guiding installation according to claim 1, further comprising a current rail located in proximity to the travel rail and wherein each of the plurality of drive carriages further comprises a current collector.

6. A guiding installation for training an animal, comprising:
(a) a travel rail positioned at a distance above a training path along which the animal travels;
(b) a guide grating traction which is suspended from and travels along the travel rail, the guide grating traction comprising at least one drive carriage and a plurality of runner carriages coupled to the drive carriage; and
(c) a plurality of guide gratings which travel around the training path, each of the guide gratings being suspended on the drive carriage or on one of the plurality of drive carriages.

7. The guiding installation according to claim 6, wherein the drive carriage comprises a motor which drives a drive wheel, and wherein the drive wheel bears upon the travel rail.

8. The guiding installation according to claim 7, wherein the drive carriage further comprises a counter thrust wheel which secures the drive wheel to the drive carriage via counter thrust.

9. The guiding installation according to claim 6, wherein each of the plurality of runner carriage comprises at least one carrier wheel which supports the weight of the runner carriage and of the guide grating on the travel rail.

10. The guiding installation according to claim 9, wherein the travel rail comprises at least two round profiles which are distanced to one another, and wherein at least one of the round profiles is a carrier profile on which the at least one carrier wheel runs.

11. The guiding installation according to claim 6, wherein each of the plurality of runner carriage comprises at least two support wheels which bear on the travel rail so that a movement of the runner carriage transverse to the travel rail is prevented.

12. The guiding installation according to claim 11, wherein the travel rail is a profile rod and comprises a carrier surface on which the support wheels of each of the plurality of runner carriages rolls.

13. The guiding installation according to claim 6, further comprising a current rail located in proximity to the travel rail and wherein the drive carriage further comprises a current collector.
